(19) United States
(12) Patent Application Publication
(10) Pub. No.: US 2006/0207522 A1
(43) Pub. Date: Sep. 21, 2006

(54) Combination pet leash assembly and waste collection device

(76) Inventor: Jerzy Perkitny, Lakewood, OH (US)

Correspondence Address: Jay F. Moldovanyi, Esq.;Fay, Sharpe, Fagan, Minnich & McKee, LLP, Seventh Floor, 1100 Superior Avenue, Cleveland, OH, 44114-2579, US

(21) Appl. No.: 11/375,780

(22) Filed: Mar. 15, 2006

Related U.S. Application Data
(60) Provisional application No. 60/662,745, filed on Mar. 17, 2005.

(51) Int. Cl. A01K 27/00

(52) U.S. Cl. 119/796

(57) ABSTRACT

The present invention relates to a connecting assembly which releasably mounts a waste collection device to one of a pet leash assembly and a clothing article worn by an operator of the waste collection device. The connecting assembly includes an engagement member having first and second spaced apart projections. The first projection is resiliently displaceable relative to the second projection such that a distance between the first and second projections is variable. The first and second projections selectively engage spaced apart apertures located in a wall of the waste collection device.

### CROSS REFERENCE TO RELATED PATENTS ANS APPLICATIONS

This application claims priority from U.S. Provisional Patent Application Ser. No. 60/662,745 filed Mar. 17, 2005 and is incorporated herein by reference.

This application is related to U.S. patent application Ser. No. 10/811,103 entitled “WASTE COLLECTION DEVICE”, commonly owned and expressly incorporated herein by reference, which claims the benefit of U.S. Provisional Patent Application Nos. 60/458,594, filed Mar. 28, 2003, and 60/476,686, filed Jun. 6, 2003, both also expressly incorporated herein by reference. This application is also related to U.S. Provisional Patent Application Ser. No. 60/662,832, filed Mar. 17, 2005, entitled “WASTE COLLECTION DEVICE” and U.S. Provisional Patent Application Ser. No. 60/662,698, filed Mar. 17, 2005, entitled “MOTORIZED PET LEASH ASSEMBLY”, both applications being expressly incorporated herein by reference and filed concurrently with the present application.

### BACKGROUND OF THE INVENTION

The present invention relates to a combination pet leash assembly and waste collection device. More particularly, the present invention relates to a connecting assembly for releasable attaching the pet leash assembly to the waste collection device.

Retractable pet leashes generally enable the user having a pet tethered to a leash cord to fluidly adapt to changing spatial relationships between the user and the pet. Conventionally, retractable leash assemblies generally operate in two modes. A first mode provides a spring loaded tension on the retractable leash cord. The spring-loaded tension causes the leash cord to retract as slack develops, extends as the owner allows the pet to roam at a further distance, and stops the leash from dragging on the ground. A second, locking, mode removes the spring-loaded tension and stops the leash from either retracting or extending.

Waste collection devices of the type disclosed in the applications mentioned above employ a liner bag, such as a disposable liner bag, to mechanically remove waste or debris (which can be liquid, solid or semi-solid) from a surface to be cleaned.

However, conventional retractable pet leashes do not include features which would allow a user to mount the pet leash to the waste collection device. Such a feature would be beneficial to the user as both units can be combined and held by the user with one hand, leaving the other hand free.

In light of the foregoing, it becomes evident that there is a need for a retractable pet leash assembly which includes a connecting assembly that would allow for the easy connection of the pet leash assembly to a waste collection device, or the like.

### SUMMARY OF THE INVENTION

In an exemplary embodiment of the present disclosure, a connecting assembly is provided.

More particularly, in accordance with this aspect of the present invention, a connecting assembly releasably mounts a waste collection device to one of a pet leash assembly and a clothing article worn by an operator of the waste collection device. The connecting assembly comprises an engagement member including first and second spaced apart projections. The first projection is resiliently displaceable relative to the second projection such that a distance between the first and second projections is variable. The first and second projections selectively engage spaced apart apertures located in a wall of the waste collection device.

In accordance with another aspect of the present invention, a connecting assembly is mounted to a housing of a pet leash assembly for releasably mounting the pet leash assembly to a waste collection device. The connecting assembly comprises an engagement member including first and second spaced apart, generally L-shaped fingers projecting from the pet leash assembly. The first finger is biased away from the second finger. The fingers selectively engage spaced apart apertures located in a wall of the waste collection device.

In accordance with yet another aspect of the present invention, a connecting assembly releasably mounts a waste collection device to an article of clothing. The connecting assembly comprises a housing and an engagement member located in the housing. The engagement member includes first and second spaced apart fingers projecting from the housing. The first finger is moveably mounted in the housing and is biased away from the second finger. The second finger is rigidly attached to the housing.

The first and second fingers selectively engage spaced apart apertures located in a wall of the waste collection device.

Still other non-limiting aspects of the present invention will become apparent from a reading and understanding of the description of the preferred embodiments hereinbelow.

### BRIEF DESCRIPTION OF THE DRAWINGS

The invention may take physical form in various components and arrangements of components, and in various steps and arrangements of steps. The drawings are only for purposes of illustrating embodiments of the invention and are not to be construed as limiting the invention.

FIG. 1 is a right side perspective view of a pet leash assembly including a connecting assembly according to a first embodiment of the present invention.

FIG. 2 is a front perspective view of the pet leash assembly of FIG. 1.

FIG. 3 is a bottom perspective view of a fold-up waste collection device in a fully folded-closed position, showing a lower wall adapted to allow the pet leash assembly of FIG. 1 to be releasably mounted thereto.

FIG. 4 is a perspective view of the pet leash assembly of FIG. 1 mounted to the fold-up waste collection device of FIG. 3.

FIG. 5A is an exploded perspective view of the connecting device of the pet leash assembly of FIG. 1.

FIG. 5B is an exploded perspective view of an alternative connecting device for the pet leash assembly of FIG. 1.

FIG. 6 is a right side elevational view of a pet leash assembly with a housing half removed, including a connecting assembly according to a second embodiment of the present invention.

FIG. 7 is a right side perspective view of the pet leash assembly of FIG. 6 being mounted to the fold-up waste collection device of FIG. 3.

FIG. 8 is a perspective view of the pet leash assembly of FIG. 6 mounted to the fold-up waste collection device of FIG. 3.

FIG. 9 is a left side cross-sectional view of the fold-up waste collection device of FIG. 3 to which is mounted a connecting assembly according to a third embodiment of the present invention.

FIG. 10 is a bottom perspective view of the fold-up waste collection device and the connecting assembly of FIG. 9.

FIG. 11 is a front perspective view of a connecting assembly for use with the fold-up waste collection device of FIG. 3 assembly according to a fourth embodiment of the present invention.

FIG. 12 is a rear perspective view of the connecting assembly of FIG. 11.

FIG. 13 is a rear elevational view of the connecting assembly of FIG. 11.

FIG. 14 is a left side cross-sectional view of the connecting assembly of FIG. 13.

### DETAILED DESCRIPTION OF THE INVENTION

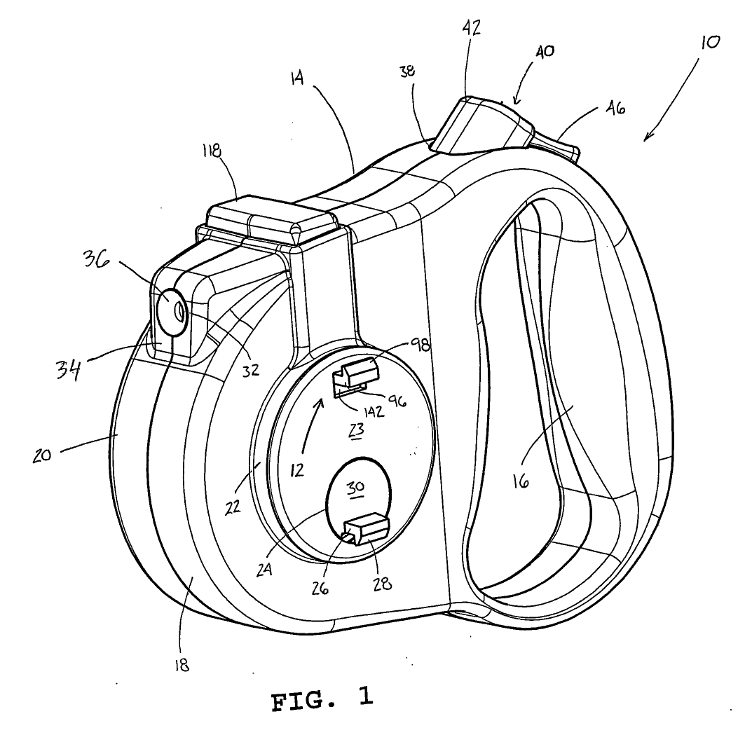

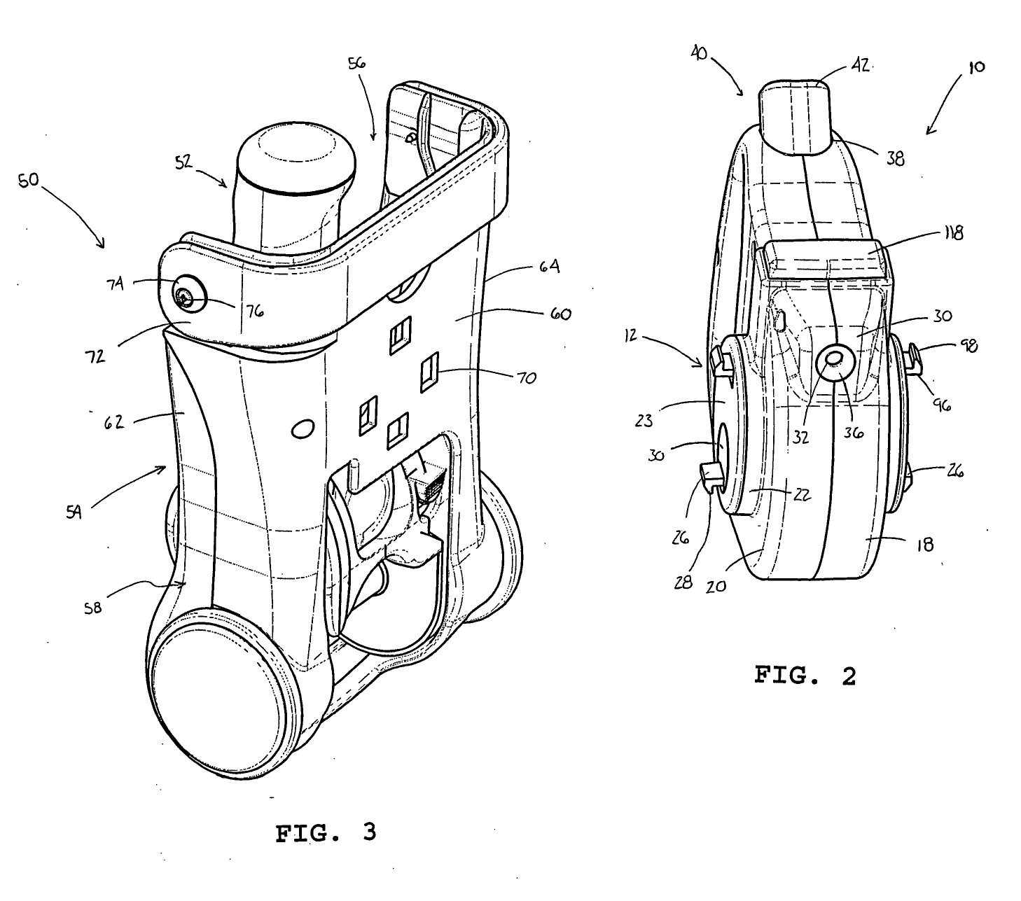

Referring now to the drawings wherein the showings are for purposes of illustrating several embodiments of the invention only and not for purposes of limiting the same, FIGS. 1 and 2 show a pet leash assembly 10 including a connecting assembly 12 according to a first embodiment of the present invention.

The pet leash assembly 10 generally includes a length of leash (not shown), such as a cord, rope, chain, and/or a webbing strip, and a housing 14. The housing 14 includes an ergonomically shaped handle or hand grip portion 16 which can be integrally fabricated with the housing. Although not illustrated, the pet leash assembly 10 further includes a spool which houses a portion of a spooling mechanism. Such spooling mechanism enables the extension and retraction of the leash. The features of the spool and spooling mechanism will be discussed in greater detail with reference to a second embodiment of the present invention.

The housing 14 can be a plastic molded component and includes first and second halves 18 and 20 that may be secured together by suitable fasteners. Each housing half includes a raised portion 22 defining an opening which is closed by a generally planar cover 23. A somewhat circular aperture 24 defined in the cover 23 is closed by a plate 30. Extending outward from the plate 30 is a first finger 26. Each finger includes a downwardly extending tab 28. In the present embodiment, the first fingers 26 are integrally formed with a plate 30 dimensioned to cover the apertures 24. However, it should be appreciated that the apertures 24 and plates 30 are not germane to the present embodiment and that the first fingers 26 can be integrally formed with the raised portions 22.

A leash opening 32 is provided in a forward facing portion 34 of the housing 14 to enable unhindered movement of the leash between the interior and exterior of the housing. An anti-wear ring 36, which can be made from a lubricious material, such as nylon, can be mounted in the leash opening 32 for buffering the leash through the leash opening to reduce the frictional wear on the leash due to the leash rubbing against the portion of the housing 14 defining the opening 32. The anti-wear ring 36 can also inhibit the leash (not shown) from forcing the housing halves 18 and 20 apart during extension and retraction of the leash.

With continued reference to FIGS. 1 and 2, the housing 14 further includes an opening 38 provided for passage of a trigger assembly 40 that can engage the spool. The trigger assembly includes a cap button 42 operatively mounted to the housing 14. The location of the trigger assembly 40 enables a user to actuate the trigger assembly with a thumb, while using the remaining fingers of the grasping hand to hold onto the grip portion 16. Actuating the trigger assembly 40 inhibits the leash from extending from the housing 14.

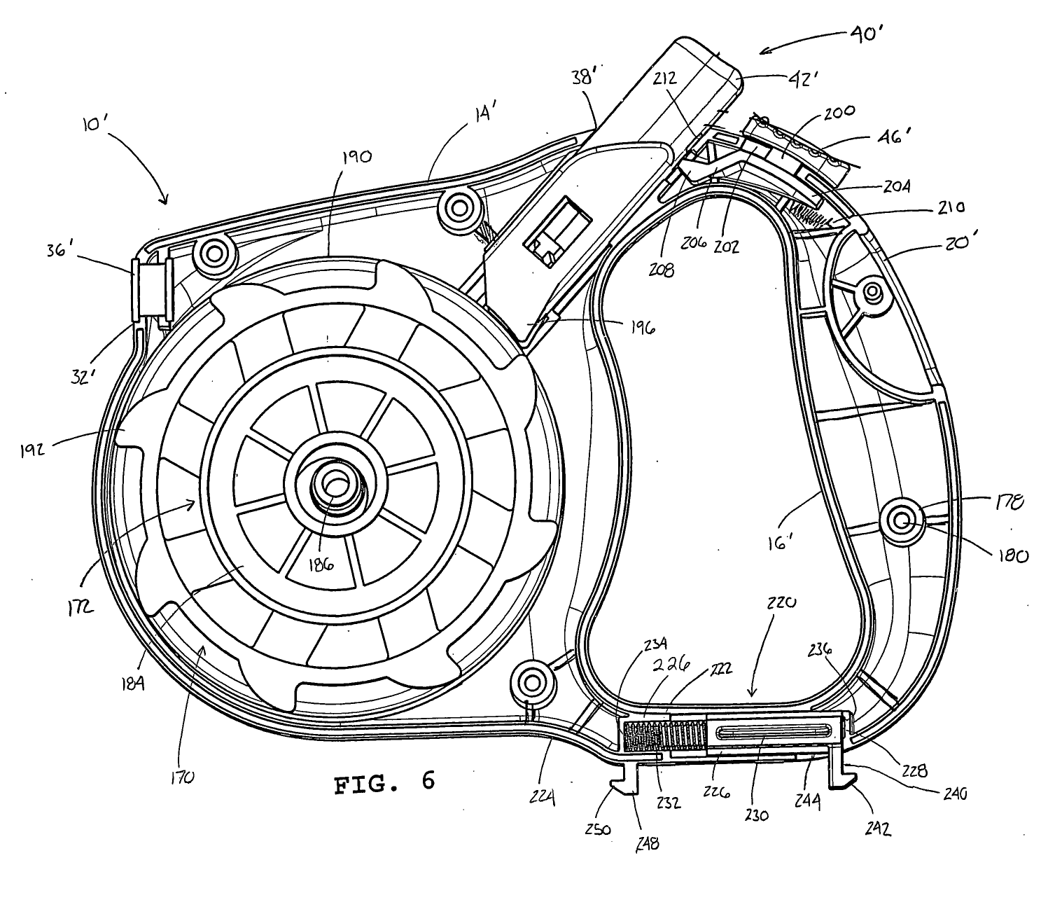

With continued reference to FIG. 1, a leash stop lock button 46 can be mounted to the housing 14, adjacent the trigger assembly 40. The spatial relationship of these two elements is more clearly illustrated in the embodiment disclosed by FIG. 6. The leash stop lock button can be located proximate to the handle grip portion 16 and operates in a first locked position to lock the spool 18, and in a second unlocked position that enables the spool to freely rotate. The trigger assembly 40 and the leash stop lock button 46 can be positioned proximate to each other so that the same hand can grasp the grip portion, actuate the trigger assembly with one finger, and operate the leash stop lock button. The location of the leash stop lock button 46 enables easy operation with the thumb of the grasping hand, thereby leaving the user's other hand completely free. The feature of the trigger assembly 40 and the leash stop lock button 46 will be discussed in greater detail below with reference to a second embodiment of the motorized pet leash assembly 10.

With reference to FIG. 3, a waste collection device, generally designated by reference numeral 50, is shown in a fully folded-up position. The waste collection device 50 includes a body having a handle assembly 52 and a housing 54 defining an opening or open end 56 of the device 50. The handle assembly can include a gripping portion which can be contoured and/or formed of a rubberized material so that a user is better able to hold and operate the waste collection device.

In FIG. 3, the waste collection device 50 is shown in the fully folded-up position wherein the handle 52 is pivotally moved against a lower wall 60 of a base portion 58 for compact storage. It should be appreciated that the device includes a fully unfolded position wherein the device is able to remove waste. In the fully unfolded position, the handle 52 is pivoted relative to the base portion 58 so that the handle is angled in relation to a plane of the housing 54, which allows the handle to be grasped by a user. For example, the handle can be oriented normal or at an obtuse angle relative to the plane of the lower wall 60.

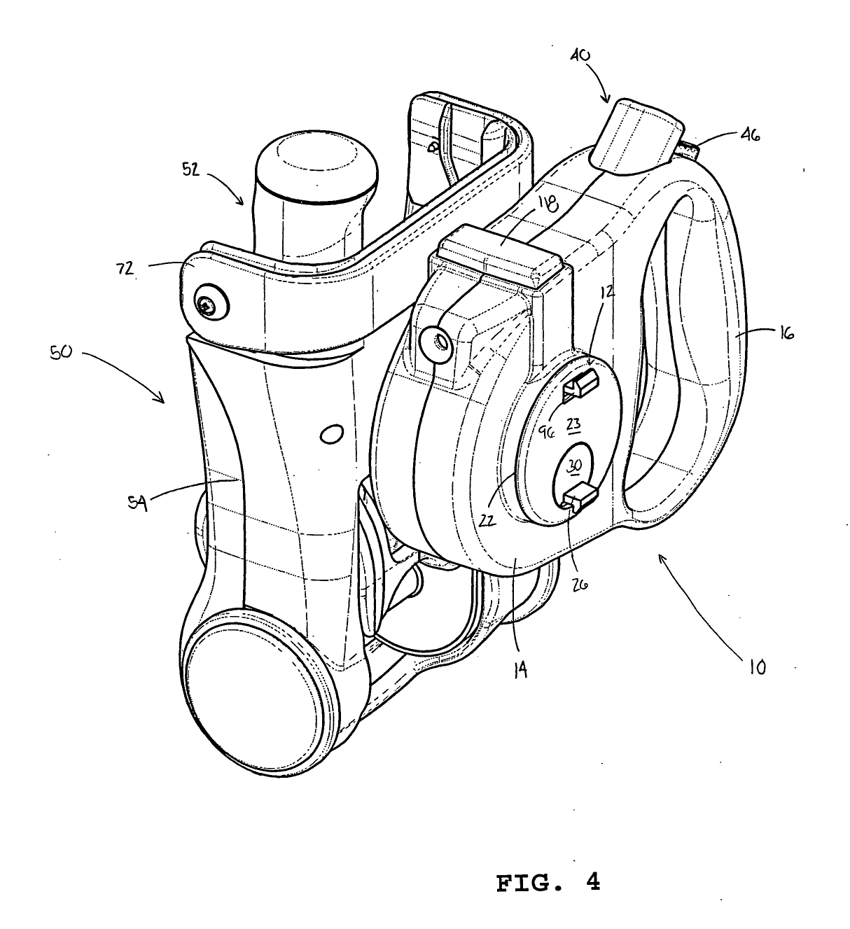

In the illustrated embodiment, the base portion 58 is U-shaped or channel-shaped. It has a substantially flat lower wall 60 and a pair of spaced apart side walls 62 and 64 extending upward from the lower wall 60. The lower wall 60 includes spaced apart apertures 70 for enabling the device 50 to be connected to the connecting assembly 12 of the pet leash assembly 10 (FIG. 4).

The body of the device 50 also includes a frame member or frame 72 pivotally mounted adjacent the open end 56 of the housing 54. The frame 72 is also U-shaped and can, together with the housing, completely form the opening 56. As shown in FIG. 3, the frame member 72 is pivotally connected to housing 54 by suitable bearing members 74 and pivot pins 76.

In many respects, the waste collection device 50 is like the waste collection devices shown and described in commonly owned U.S. patent application Ser. No. 10/811,103, expressly incorporated herein by reference. To the extent possible, other features discussed in reference to one or more of the embodiments of the above-referenced '103 application can also be optionally included on the device 50.

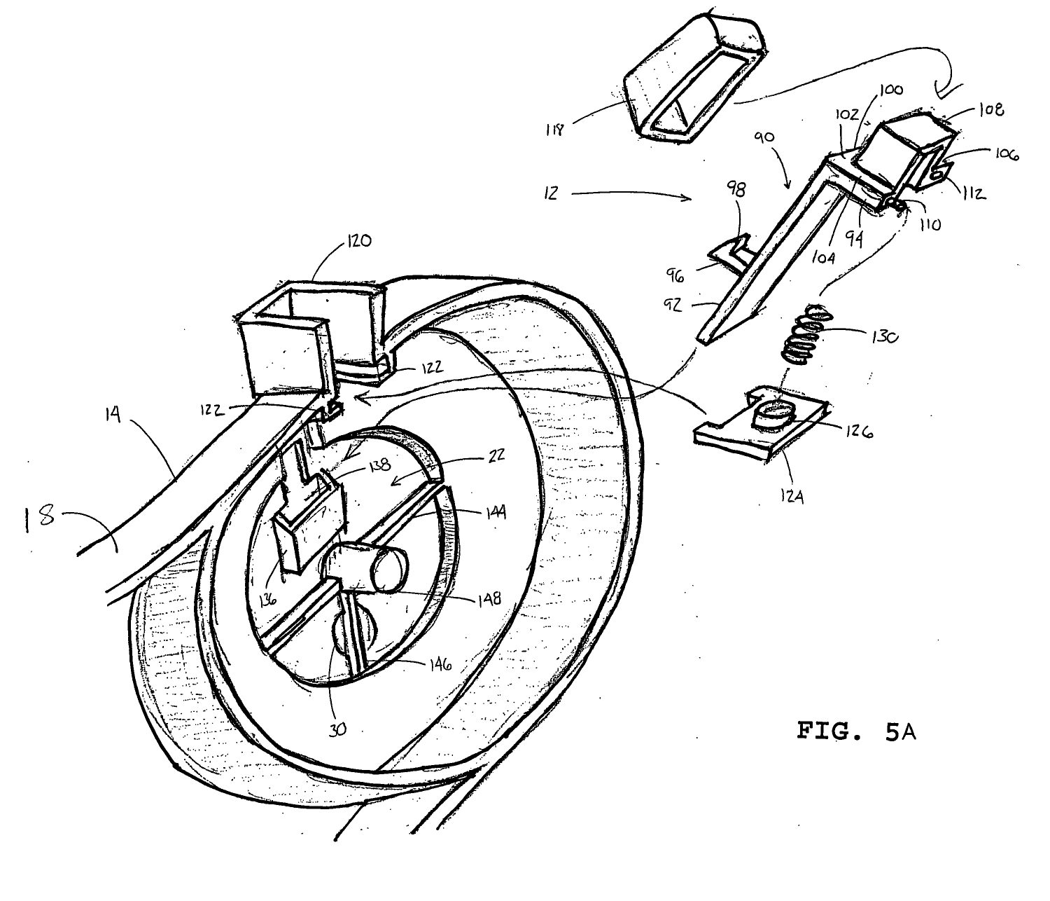

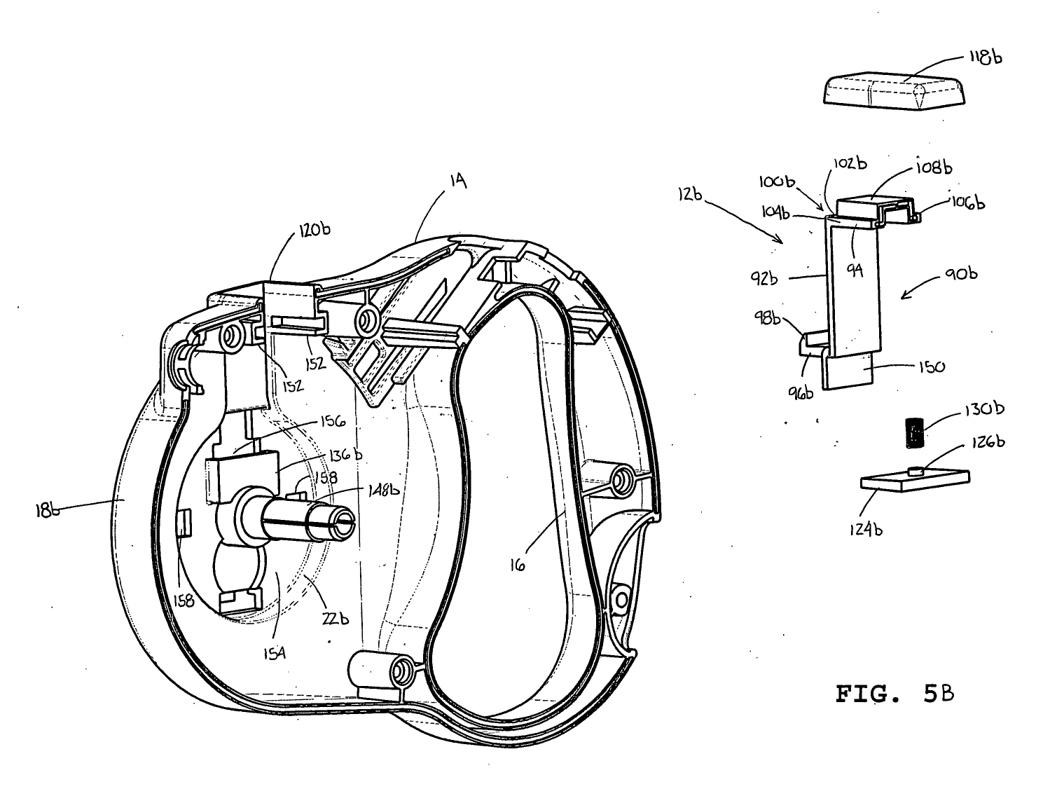

With reference now to FIG. 5A, a part of the connecting assembly 12 for releasably attaching the pet leash assembly 10 to the waste collection device 50 is illustrated. The connecting assembly 12 generally includes first and second engagement members extending from the first and second halves 18 and 20, respectively, of the housing 14. It is apparent that only one of these is illustrated. In this embodiment, the each engagement member includes a generally L-shaped part 90, having a first portion 92 and a second portion 94. A second finger 96 including an upwardly extending tab 98 extends outwardly from the first portion 92. As will be discussed in greater detail below, second finger 96 and spaced apart first finger 26 can be selectively secured in the apertures 70 of the lower wall 60 of the waste collection device 50 thereby enabling the pet leash assembly 10 to be connected to the waste collection device 50.

With continued reference to FIG. 5A, the second portion 94 includes a generally C-shaped shelf 100 having a base portion 102 and a pair of arms 104 and 106. A cap 108 extends upwardly from the shelf. The shelf 100 further includes a pin 110 extending laterally from one arm and an aperture 112 located in the other arm. The L-shaped parts 90 of the first and second engagement members are secured to each other by inserting the respective pins 110 of the parts into in the respective apertures 112 of the parts. Once secured together, a cap button 118 can be mounted over the caps 108 thereby further securing the L-shaped parts to each other.

As shown in FIG. 5A, the first half 18 of the housing 14 includes a first extension 120 dimensioned to receive the second portion 94 of the L-shaped part 90 and a portion of the cap button 118. A pair of L-shaped tabs 122 extend into the housing 14 adjacent the first extension 120. They define a channel dimensioned to receive a plate 124. The plate includes a cylindrical hollow projection 126 for receiving thereon a spring 130. The spring is positioned in a compressed state between an inner top surface of the cap 108 and the plate 124. Thus, the spring outwardly biases the cap 108 and the cap button 118. It should be apparent that the second housing half 20 is similarly constructed.

The first housing half 18 further includes a socket 136 having an opening 138 dimensioned to receive the first portion 92 of the L-shaped part 90. As illustrated in FIG. 5A, the socket 136 extends downward into the opening defined by the raised portion 22 from a top portion of the housing 14. Thus, the finger 96 of the L-shaped member 90 projects outward from each half 18 and 20 of the housing 14 and through a slotted aperture 142 located in the cover 23 (FIG. 1). A pair of support ribs 144 and 146 extend, in a cross configuration, across the opening defined by the raised portion 22. The plate 30 can also be attached to support member 146. A shaft 148 can extend from the intersection of the support members for rotatably supporting the spool (not shown) thereby allowing the spool to freely rotate in the housing 14.

With reference to FIG. 5B, an alternative connecting assembly 12b for releasably attaching the pet leash assembly 10 to the waste collection device 50 is illustrated. In this embodiment, an engagement member of the connecting assembly 12b is also generally L-shaped part 90b, having a first portion 92b and a second portion 94b. Extending from an end of the first portion 92b is a generally L-shaped tab 150. A second finger 96b including an upwardly extending tab 98b extends outwardly from the L-shaped tab 150. The second portion 94b includes a generally C-shaped shelf 100b having a base portion 102b and a pair of arms 104b and 106b. A cap 108b extends upwardly from the shelf.

As shown in FIG. 5B, the first half 18b of the housing 14 includes a first extension 120b dimensioned to receive the second portion 94b of the L-shaped part 90b and a portion of a cap button 118b. A pair of C-shaped slots 152 extends into the housing 14 adjacent the first extension 120b. They define a channel dimensioned to receive a plate 124b. The plate includes a cylindrical projection 126b for receiving thereon a spring 130b.

With continued reference to FIG. 5B, the first housing half 18b includes a raised portion 22b and a socket 136b formed on an inner surface 154 of the raised portion. An opening 156 in the raised portion 22b adjacent the socket is dimensioned to receive the first portion 92b of the L-shaped part 90b. Thus, the finger 96b of the L-shaped member 90b projects outward from the housing 14 and through a slotted aperture 142 located in a cover. To secure the L-shaped part 90b in the socket 136b, the tab 150 is first in inserted in the socket, a portion of the tab 150 extending out of the opening 156. The L-shaped part 90b is then rotated upward into the extension 120b and the plate 124b is then inserted into the channel defined by the C-shaped tabs 152.

A shaft 148b can extend from the raised portion 22b for rotatably supporting the spool (not shown). A pair of apertures 158 is located in the raised portion 22b for receiving corresponding tabs (not shown) on a cover, the tabs securing the cover to the raised portion.

To attach the pet leash assembly 10 to the waste collection device 50, the user depresses the cap button 118 which, in turn, depresses the first and second L-shaped parts 90 into the housing 14 of the leash assembly 10. This downward movement of the L-shaped parts 90 decreases the spacing between the second, movable finger 96 and first fixed finger 26. As the spacing between the fingers decreases, the both fingers can be inserted into the apertures 70 of the lower wall 60 of the waste collection device 50, the tabs 28 and 98 of the fingers 26 and 96, respectively, engaging an inner surface (not shown) of the lower wall 60. Once inserted, the user releases the cap button 118, the spring 130 biasing the first and second L-shaped parts 90 back to their original position. As the L-shaped parts 90 move upward, the spacing between the fingers 26 and 96 increases thereby locking the fingers in the apertures 70 of the waste collection device 50. Detaching the leash assembly 10 from the waste collection device 50 requires a reversal of the steps outlined above.

Similar to the aforementioned embodiment, a second embodiment of the connecting assembly is shown in FIGS. 6-8. Since most of the structure and function is substantially identical, reference numerals with a single primed suffix (′) refer to like components (e.g. the pet leash assembly is referred to by reference numeral 10′), and new numerals identify new components in the additional embodiment.

With reference to FIG. 6, a pet leash assembly 10′ includes a housing 14′ having an ergonomically shaped handle 16′ which can be integrally fabricated with the housing and a spool 170 which houses a portion of a spooling mechanism 172. The spooling mechanism enables a leash (not shown) to extend and retract from the housing 14′.

The housing 14′ can be a plastic molded component and includes first and second halves 18′ and 20′ that may be secured together by suitable fasteners. In this embodiment, a plurality of corresponding bosses 178 extend outwardly from the two halves, each boss including an aperture 180 for receiving a fastener (not shown) which threadingly engages the aperture from the exterior of one of the first and second halves 18′, 20′. A leash opening 32′ is provided in a forward facing portion 34′ of the housing. An anti-wear ring 36′, which can be made from a lubricious material, such as nylon, can be mounted in the leash opening 32′.

The housing 14′ further includes an opening 38′ provided for passage of a trigger assembly 40′ that can engage the spool 170. The trigger assembly includes a cap button 42′ operatively mounted in the housing 14′. A compression spring (not visible) can be secured in the cap button to outwardly bias the cap button. Actuating the trigger assembly 40′ inhibits the leash from extending from the housing 14′.

In particular, and as shown in FIG. 6, the spooling mechanism includes a power spring (not shown) and a spool cover 184. A stationary axle 186 extends from the housing half 20′. A radially outer end (not shown) of the power spring attaches to the spool 170 to fasten the power spring in a rotatable spool cavity (not shown). The spool 170 and the attached power spring fit onto the axle 186. When mounted on the axle, a radially inner end (not shown) of the power spring is secured to a portion of the axle 186. The spool cover 184 fastens over the power spring to secure the power spring in the spool cavity. The power spring is initially coiled to spring bias the spool 170 to retract the leash. Additionally, as the spool rotates to extend the leash out of the housing 14′, the power spring coils further, thereby providing additional retracting bias as the extended portion of the leash increases. The outer surface 190 of the spool 170 is adapted for spooling the leash.

The spool 170 includes several teeth 192 spaced around the circumference of an outer facing portion and the circumference of an inner facing portion of the spool. The teeth 192 are adapted for engaging a first rotation inhibitor portion 196 of the trigger assembly 40′.

With continued reference to FIG. 6, a leash stop lock button 46′ can be mounted to the housing 14′, adjacent the trigger assembly 40′ such that when a user is gripping the handle portion 16′, the stop lock button may be activated by a finger of the same hand holding the handle portion. The leash stop lock button 46′ is connected to a post 200 extending through a slotted opening 202 in the housing 14′. A base 204 is secured to the post and an arm 206 including a tab 208 extends from the base. A compressed spring 210 is secured at one end to a portion of the housing 20′ and at the otherend to the base 204. In an unlocked position, the tab 208 is located adjacent the cap button 42′. As the cap button 42′ is depressed, an opening 212 in the cap button 42′ will be aligned with the tab 208 and the spring 210 will cause the tab to engage the opening 212. Thus, the leash stop lock button 46′ can automatically lock the cap button in the depressed state thereby locking the rotation inhibitor portion 196 into engagement with the teeth 192 which restricts the rotation of the spool 170.

As illustrated in FIG. 6, the pet leash assembly 10′ further includes a connecting assembly 220 housed in a compartment 222 located in a bottom portion 224 of the housing 14′. The connecting assembly 220 includes a socket 226 fixed to the housing 14′ and a movable member 228 received within the housing 14′. In the present embodiment, the movable member has a barrel-like configuration, however, it should be appreciated that other configurations, such as a hexagonal configuration, can be used without departing from the scope of the present invention. The movable member 228 can include a pair of diametrically opposed guides 230 that are received in corresponding slots (not shown) of the housing 14′ for guiding movement of the movable member. A spring 232 is disposed between a first end wall 234 of the socket 226 and an end of the movable member 228. The spring 232 urges the movable member 228 against a second end wall 236 of the compartment.

A finger 240 including a tab 242 extends downward from an end portion of the movable member 228, the finger projecting through a slotted opening 244 in the bottom portion 224 of the housing 14′. A second finger 248 including a second tab 250 also extends downward from the bottom potion 224 of the housing 14′. The second finger is fixed, being integral with the bottom portion.

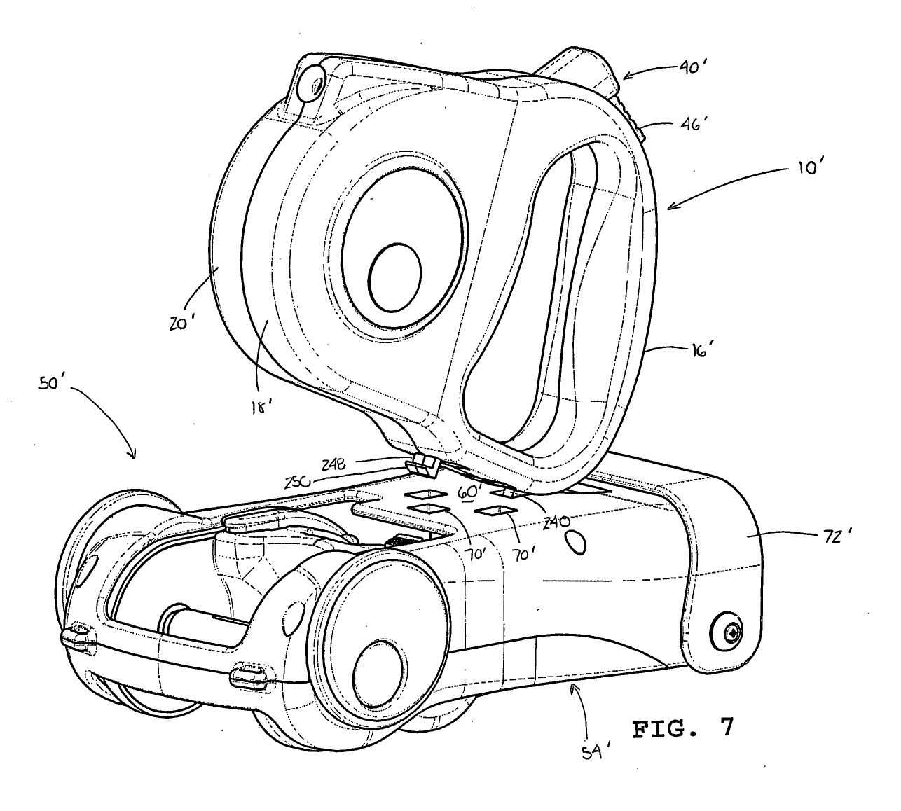

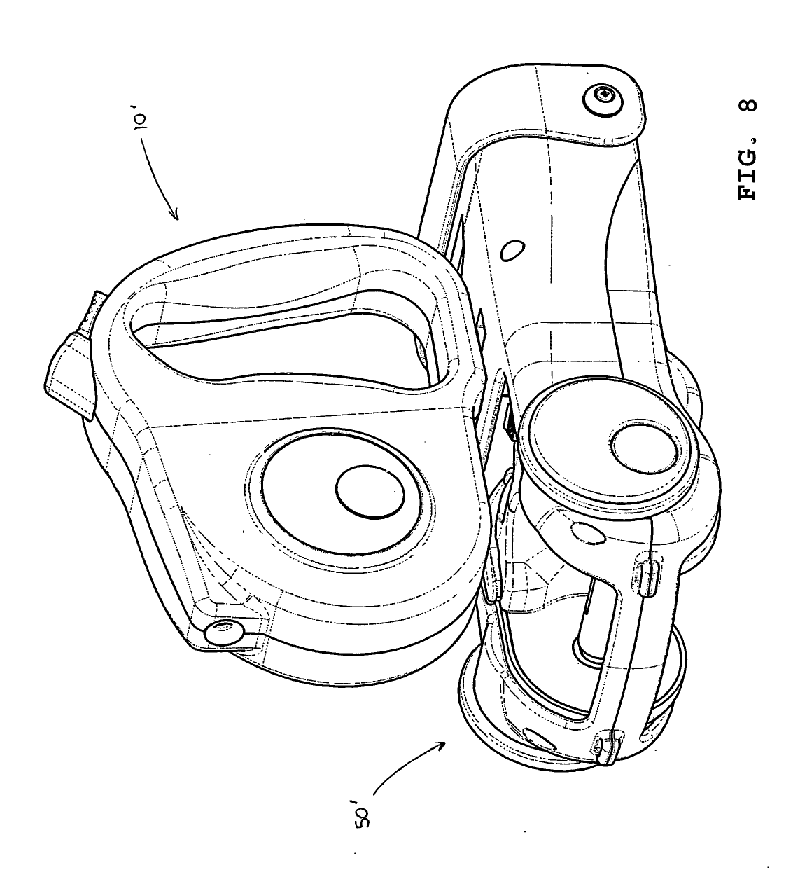

Similar to the first embodiment, the spacing between the fingers 240 and 248 is larger than the spacing between the apertures 70′ of the lower wall 60′ of the waste collection device 50′. Thus, and as shown in FIGS. 7 and 8, in order to mount the pet leash assembly 10′ to the waste collection device 50′, the first finger 240 is inserted into one of the apertures 70′, the tab 242 of the first finger engaging an inner surface (not shown) of the lower wall 60′. To insert the second finger 248, the user can pull the pet leash assembly 10′ by the handle 16′ which will compress the spring 232 and slidingly move the finger 240 in the slotted opening 244 towards the second finger 248 thereby decreasing the spacing between the fingers 240 and 248. This decreased spacing allows the second finger 248 to be inserted in the other aperture 70′, the tab 250 of the second finger also engaging the inner surface of the lower wall 60′. As the user releases the handle 16′, the first finger 240 biases back against the end wall 236. As the first finger moves, the spacing between the fingers 240 and 248 increases thereby locking the fingers into the apertures 70′ of the waste collection device 50′.

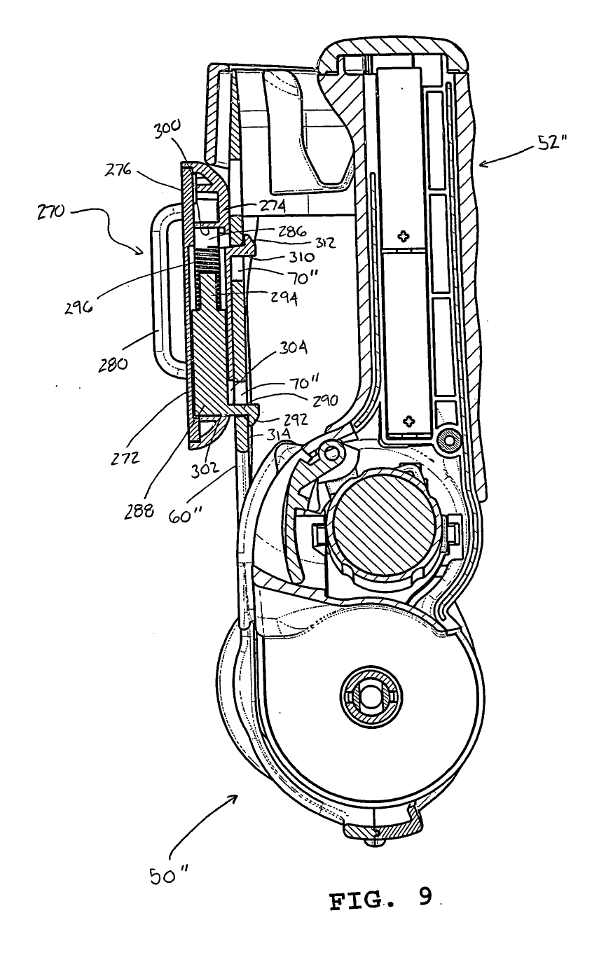

Similar to the aforementioned embodiments, a third embodiment of the connecting assembly is shown in FIGS. 9 and 10. Since some of the structure and function is substantially identical, reference numerals with a double primed suffix (″) refer to like components (e.g. the waste collection device is referred to by reference numeral 50″), and new numerals identify new components in the additional embodiment.

With reference to FIGS. 9 and 10, the connecting assembly 270 includes a housing 272, which can be a plastic molded component, including a tub-shaped portion 274 and a plate portion 276. These two portions can be secured together by suitable fasteners. A pair of spaced loop members 280 extends outward from a pair of slots 282 located in the plate portion 276. The loop members 280 can be integrally formed with one of the plate portion and bottom tub-shaped portion. The loop members 280 are adapted to receive a conventional belt (not shown) worn by the user of the waste collection device 50″. Thus, once the connecting assembly 270 is attached to the belt by threading the belt through the loop members 280, the waste collection device can be mounted to the connecting assembly 270 (in a manner to be discussed in greater detail below).

As shown in FIG. 9, the connecting assembly 270 includes a compartment 286 which houses an engagement member 288. Similar to the second embodiment, the engagement member can have a barrel-like configuration. The barrel member includes an integral first finger 290 having a tab 292 at one end and a projection 294 extending axially from the other end. The projection is adapted to slidingly receive a spring 296. The spring 296 is positioned in a compressed state between a first end wall 300 of the compartment 286 and the barrel member 288. Thus, the spring biases the barrel member 288 against a second end wall 302 of the compartment.

The first finger 290 extends through a slotted opening 304 located in the tub-shaped portion 274 thereby allowing the finger to selectively move relative to a second finger 310 integrally formed in the top portion. Similar to the first finger 290, the second finger 310 also extends outward from the top portion and includes a tab 312.

Similar to the second embodiment, the spacing between the fingers 290 and 310 is larger than the spacing between the apertures 70″ of the lower wall 60″ of the waste collection device 50″. Thus, and as shown in FIG. 9, in order to mount the connecting assembly 270 to the waste collection device 50″, the first finger 290 is inserted into one of the apertures 70″, the tab 292 engaging an inner surface 314 of the lower wall 60″. A user can then pull the waste collection device upward thereby compressing the spring 296 and slidingly moving the first finger 290 in the slotted opening 304 towards the second finger 310 thereby decreasing the spacing between the fingers 290 and 310. This decreased spacing allows the second finger 310 to be inserted in the other aperture 70″, the tab 312 also engaging the inner surface 314 of the lower wall 60″. The user then releases the waste collection device which then biases the first finger 290 back against the end wall 302. As the first finger moves, the spacing between the fingers 290 and 310 increases thereby locking the fingers into the apertures 70″ of the waste collection device 50″.

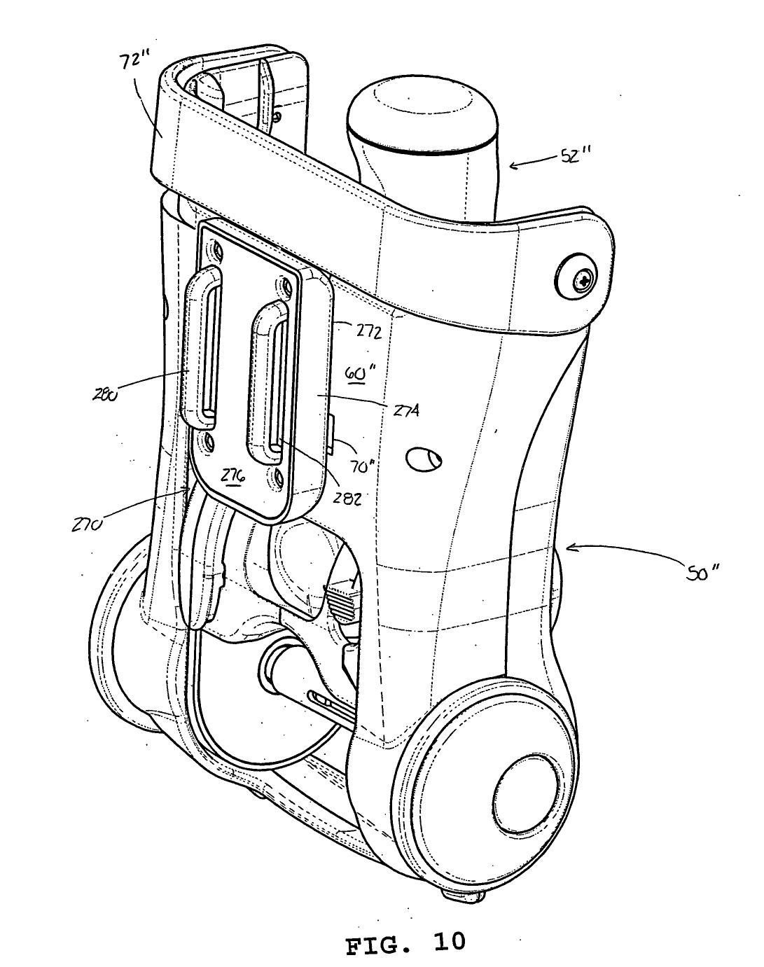

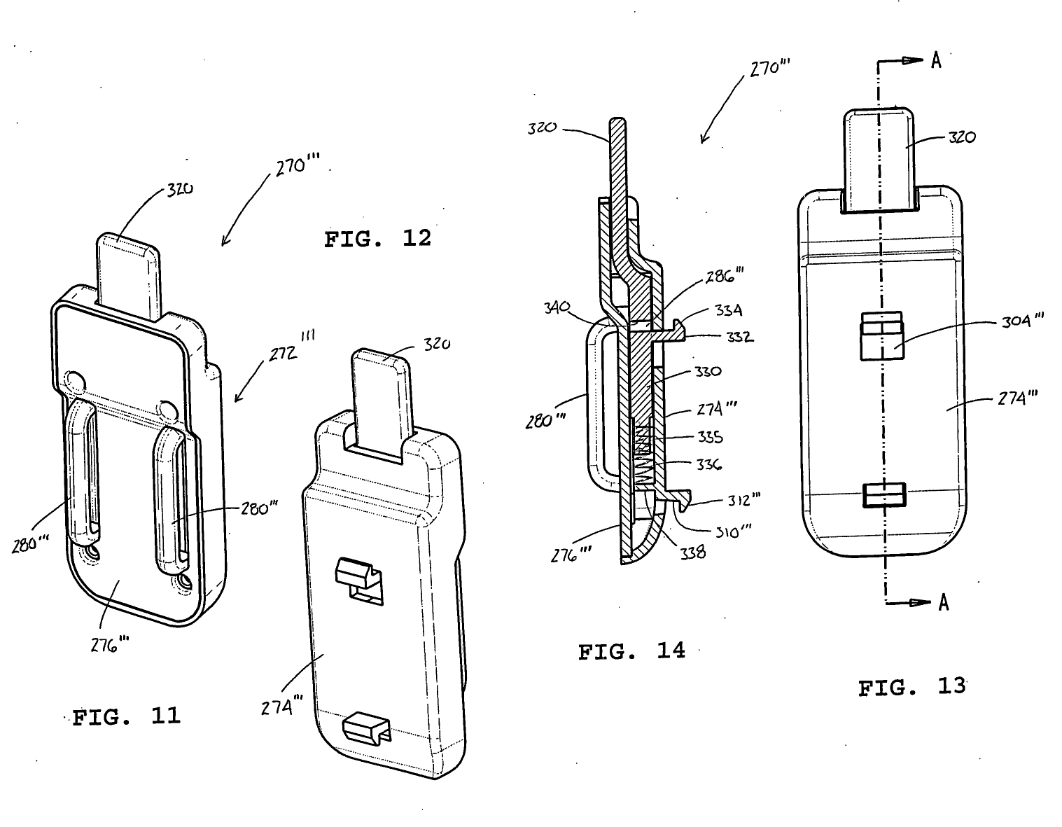

Similar to the aforementioned third embodiment, a fourth embodiment of the connecting assembly is shown in FIGS. 11-14. Since most of the structure and function is substantially identical, reference numerals with a triple primed suffix (′″) refer to like components (e.g. the connecting assembly is referred to by reference numeral 270′″), and new numerals identify new components in the additional embodiment.

As shown in FIGS. 11-14, the connecting assembly 270′″ includes a housing 272′″, which can be a plastic molded component, including a tub-shaped portion 274′″ and a plate portion 276′″ which may be secured together by suitable fasteners. A button 320 extends from the housing 272′″. A pair of spaced loop members 280′″ extends outward from the plate portion 276′″.

The connecting assembly 270′″ further includes a compartment 286′″ which houses an engagement member 330. The engagement member includes an integral finger 332 having a tab 334 at one end and a projection 335 extending axially from the other end. The projection is adapted to slidingly receive a spring 336 positioned in a compressed state between an end wall 338 of the compartment 286′″ and the engagement member 330. Thus, the spring biases the engagement member 330 against an end 340 of the button 320. In use, the button 320 assists the user in actuating the connecting assembly 270′″. As the button is depressed, the end 340 will contact the engagement member 330 and move the engagement member including the finger 332 towards the end wall 338.

As to a further discussion of the manner of usage and operation of the fourth embodiment, the same should be apparent from the above description relative to the third embodiment. Accordingly, no further discussion relating to the manner of usage and operation will be provided.

The present invention has been described with reference to the preferred embodiments. Obviously, modifications and alterations will occur to others upon reading and understanding the preceding detailed description. It is intended that the present invention be construed as including all such modifications and alterations insofar as they come within the scope of the appended claims or the equivalents thereof.

What is claimed is:

1. A connecting assembly for releasably mounting a waste collection device to one of a pet leash assembly and a clothing article worn by an operator of the waste collection device, the connecting assembly comprising:
an engagement member including first and second spaced apart projections, the first projection being resiliently displaceable relative to the second projection such that a distance between the first and second projections is variable, the first and second projections selectively engaging spaced apart apertures located in a wall of the waste collection device.

2. The connecting assembly of claim 1, wherein each projection is generally L-shaped.

3. The connecting assembly of claim 1, wherein the first and second projections extend outwardly from a housing of the pet leash assembly, wherein the second projection is fixed relative to the housing.

4. The connecting assembly of claim 1, further comprising a trigger assembly including a spring biased reciprocating member for selectively moving the first projection towards the second projection.

5. The connecting assembly of claim 4, wherein the trigger assembly is mounted to a housing of the pet leash assembly, the pet leash assembly including a socket having an opening dimensioned to receive the reciprocating member.

6. The connecting assembly of claim 1, further comprising a reciprocating member, wherein at least one of the projections is connected to and extends outwardly from the reciprocating member.

7. The connecting assembly of claim 7, wherein the reciprocating member includes an arm adapted to slidingly receive a spring for biasing the first projection away from the second projection.

8. The connecting assembly of claim 7, wherein the reciprocating member is mounted in a housing of the pet leash assembly.

9. The connecting assembly of claim 8, wherein the reciprocating member includes at least one guide received in a corresponding slot of the housing for guiding a movement of the reciprocating member.

10. The connecting assembly of claim 1, further comprising at least one loop member adapted to receive a clothing article.

11. A connecting assembly mounted to a housing of a pet leash assembly for releasably mounting the pet leash assembly to a waste collection device, the connecting assembly comprising:
an engagement member including first and second spaced apart, generally L-shaped fingers projecting from the pet leash assembly, the first finger being biased away from the second finger, the fingers selectively engaging spaced apart apertures located in a wall of the waste collection device.

12. The connecting assembly of claim 11, wherein the second finger is fixed relative to the housing of the pet leash assembly.

13. The connecting assembly of claim 11, further comprising a reciprocating member, the first finger extending outwardly from the reciprocating member.

14. The connecting assembly of claim 13, further comprising a trigger mounted to the housing of the pet leash assembly for selectively moving the reciprocating member towards the second finger.

15. The connecting assembly of claim 13, wherein the reciprocating member includes an arm adapted to slidingly receive a spring for biasing the first finger away from the second finger.

16. A connecting assembly for releasably mounting a waste collection device to an article of clothing, the connecting assembly comprising:
a housing;
an engagement member located in the housing, the engagement member including first and second spaced apart fingers projecting from the housing, the first finger being moveably mounted in the housing and biased away from the second finger, the second finger being rigidly attached to the housing, the first and second fingers selectively engaging spaced apart apertures located in a wall of the waste collection device.

17. The connecting assembly of claim 16, further comprising at least one loop member mounted to the housing, the at least one loop member adapted to receive a clothing article.

18. The connecting assembly of claim 16, further comprising a reciprocating member, the first finger being secured to and extending outwardly from the reciprocating member.

19. The connecting assembly of claim 18, further comprising a trigger mounted to the housing, the trigger selectively engaging and moving the reciprocating member towards the second fixed finger.

20. The connecting assembly of claim 18, wherein the reciprocating member includes an arm adapted to slidingly receive a spring for biasing the first finger away from the second finger.
